(19) United States
(12) Patent Application Publication
(10) Pub. No.: US 2009/0269114 A1
(43) Pub. Date: Oct. 29, 2009

(54) PROTECTIVE CLAW, PROCESS CARTRIDGE AND IMAGE FORMING APPARATUS

(75) Inventor: Keiji Yuge, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/423,852

(22) Filed: Apr. 15, 2009

(30) Foreign Application Priority Data
Apr. 25, 2008 (JP) 2008-115169

(51) Int. Cl. G03G 15/14

(52) U.S. Cl. 399/399

(57) ABSTRACT

A protective claw provided on an upstream side of a cleaning device in a rotational direction of an image carrying member includes a main body, a recording material receiving portion formed on the main body so as to receive a recording material from a leading end thereof, and a rotating shaft, when receiving the recording material by the recording material receiving portion, to support the main body so as to make the recording material receiving portion rotate in a direction separating from the image carrying member.

### CROSS-REFERENCE TO RELATED APPLICATION

This application is based upon and claims the benefit of priority from the prior Japanese Patent Application No. 2008-115169, filed on Apr. 25, 2008; the entire contents of all of which are incorporated herein by reference.

### FIELD OF THE INVENTION

The present invention relates to, in an image forming apparatus, a protective claw for preventing a recording material from entering a cleaning device and more particularly to a protective claw characterized in the shape thereof.

### DESCRIPTION OF THE BACKGROUND

In an electro-photographic image forming apparatus, there is a problem imposed that a recording material passing through a transfer portion for transferring a toner image formed on the surface of a photoconductor to the recording material is not separated from the photoconductor as attracted to the photoconductor, thereby causes jamming. To solve such a problem, by a recording material separation means such as a discharging needle or separation corona discharge, after transfer, the recording material is prevented from adhering to the photoconductor.

However, although the recording material separation means is provided like this, there is a case that the recording material is not always separated from the photoconductor, causing defective conveyance. The recording material not separated from the photoconductor is conveyed to the cleaning portion (cleaning device) provided at the succeeding stage of the transfer device and enters inside the cleaning device. Inside the cleaning device, collected discharged toner is stored. Therefore, if the recording material enters the cleaning device, the discharged toner collected by the cleaning device is adhered to the recording material, thus a problem arises that when removing the recording material, the main body is internally contaminated. Furthermore, there is a fear that an internal member of the cleaning device, for example, the cleaning blade may be damaged.

In Japanese Patent Application Publication No. 10-186868, to prevent a recording material causing defective separation from entering the cleaning device, a protective claw provided on the upstream side of the cleaning device is disclosed.

The preventive claw of a conventional image forming apparatus is arranged so that the leading end portion of the protective claw makes contact with or approaches the photoconductor in the opposite direction to the rotational direction of the photoconductor. Therefore, the photoconductor surface is damaged during operation over a long period of time, thus defective image formation is caused.

### SUMMARY OF THE INVENTION

The present invention is intended to provide a protective claw for reducing the load on the photoconductor, a process cartridge, and an image forming apparatus.

In an aspect of the present invention, a protective claw provided on an upstream side of a cleaning device in a rotational direction of an image carrying member is provided and the protective claw comprises a main body; a recording material receiving portion formed on the main body so as to receive a recording material from a leading end thereof; and a rotating shaft, when receiving the recording material by the recording material receiving portion, configured to support the main body so as to make the recording material receiving portion rotate in a direction separating from the image carrying member.

Furthermore, in an aspect of the present invention, a process cartridge is provided and the process cartridge comprises an image carrying member; a charger arranged in a rotational direction of the image carrying member configured to charge the image carrying member; an exposure device to irradiate light to the charged image carrying member and form an electrostatic latent image; a developing device to supply toner to the electrostatic latent image and form a toner image on the image carrying member; a transfer device to transfer the toner image onto a recording material; a cleaning device configured to remove toner remaining on the image carrying member after transferring the toner image onto the recording material; and a protective claw provided on an upstream side of the cleaning device in the rotational direction of the image carrying member, wherein the protective claw comprises: a main body; a recording material receiving portion formed on the main body so as to receive the recording material from a leading end thereof; and a rotating shaft, when receiving the recording material by the recording material receiving portion, configured to support the main body so as to make the recording material receiving portion rotate in a direction separating from the image carrying member.

Further in an aspect of the present invention, an image forming apparatus is provided and the image forming apparatus comprises an image carrying member; a charger arranged in a rotational direction of the image carrying member to charge the image carrying member; an exposure device to irradiate light to the charged image carrying member and form an electrostatic latent image; a developing device to supply toner to the electrostatic latent image and form a toner image on the image carrying member; a transfer device to transfer the toner image onto a recording material; a fixing device configured to fix the transferred toner image on the recording material; a cleaning device configured to remove toner remaining on the image carrying member after transferring the toner image onto the recording material; and a protective claw provided on an upstream side of the cleaning device in the rotational direction of the image carrying member, wherein the protective claw comprises: a main body; a recording material receiving portion formed on the main body so as to receive the recording material from a leading end thereof; and a rotating shaft, when receiving the recording material by the recording material receiving portion, configured to support the main body so as to make the recording material receiving portion rotate in a direction separating from the image carrying member.

### BRIEF DESCRIPTION OF THE DRAWINGS

FIG. 1 is an internal schematic view showing the image forming apparatus which is an embodiment of the present invention;

FIG. 2 is a cross sectional view of the process cartridge;

FIG. 3 is a cross sectional view of the protective claw provided on the lower part of the cleaning device;

FIG. 4 is a cross sectional view of the protective claw;

FIG. 5 is a drawing for explaining the respective units composing the protective claw;

FIG. 6 is a drawing for explaining the movement of the protective claw;

FIG. 7 is a drawing for explaining the operation of the protective claw;

FIG. 8 is a drawing for explaining the operation of the protective claw when the recording material enters therein;

FIGS. 9A and 9B are drawings for explaining the protective claw positioning portion of the protective claw;

FIG. 10 is a cross sectional view of the switch provided on the upper part of the protective claw; and

FIG. 11 is a drawing for explaining the operation of the protective claw to make contact with the switch when the recording material enters the protective claw.

### DETAILED DESCRIPTION OF THE INVENTION

### Embodiment

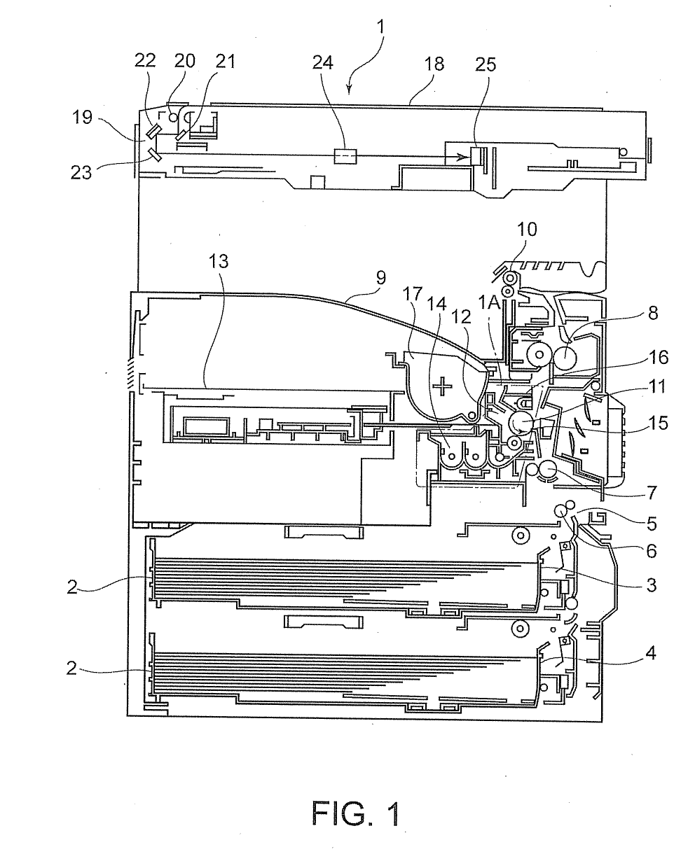

FIG. 1 is an internal schematic view showing the image forming apparatus which is an embodiment of the present invention. Below a main body 1, plural-stage sheet supply cassettes 3 and 4 for storing recording materials 2 are provided.

The recording material 2 is conveyed upward via a conveying system 5. In the conveying system 5, a conveying roller 6 for conveying the recording material 2 to a process cartridge 1A, an aligning roller 7, a fixing device 8, and discharge rollers 10 for discharging the recording material 2 with an image recorded to a receiving tray 9 are arranged.

At the central part inside the image forming apparatus 1, the process cartridge 1A is provided removably on the image forming apparatus 1. The process cartridge 1A has a photosensitive drum 11 as an image carrying member attached rotatably. On the peripheral part of the photosensitive drum 11, in the direction of the arrow (counterclockwise), a corona-discharge type charger 12, an exposure device 13, a developing device 14, a transfer device 15, and a cleaning device 16 are arranged. Above the developing device 14, a toner bottle 17 is provided removably on the image forming apparatus 1.

In the upper region of the image forming apparatus 1, a document table 18 is provided. On the lower part of the document table 18, a scanner 19 for reading a document on the document table 18 is provided. The scanner 19 includes a light source 20 for irradiating light to the document, a first reflection mirror 21 for reflecting light reflected from the document in a predetermined direction, second and third reflection mirrors 22 and 23 for reflecting sequentially light reflected from the first reflection mirror 21, a focusing lens 24 for imaging the reflected light from the third reflection mirror 23 on the image forming surface of a light receiving element 25, and the light receiving element 25 for receiving the light imaged by the focusing lens 24.

The operation of each device at the time of image formation will be explained. Firstly, when reading a document put on the document table 18, light is irradiated to the document from the light source 20. The light is reflected from the document and is received by the light receiving element 25 via the first reflection mirror 21, second reflection mirror 22, and third reflection mirror 23, thus the document image is read. Here, the first reflection mirror 21, by a drive means not drawn, moves from the underneath of the light source 20 shown in FIG. 1 in the longitudinal direction of the document and reads the document. At this time, to keep the optical path length, which is a distance between the document and the image forming surface of the light receiving element 25, unchanged, the second reflection mirror 22 and third reflection mirror 23 also move.

On the basis of the reading information, a laser beam is irradiated to the photosensitive drum 11 from the exposure device 13. The surface of the photosensitive drum 11 is charged uniformly by the charger 12 and is irradiated with the laser beam of the intensity modulated depending on the image information from the exposure device 13, thus an electrostatic latent image having a residual charge of the image to be copied on the photosensitive drum 11 is formed.

The electrostatic latent image formed on the photosensitive drum 11 is adhered with toner charged at a reverse polarity of that of the electrostatic latent image by the developing device 14 to form a toner image. And, the toner adhered to the electrostatic latent image is conveyed from the underneath of the process cartridge 1A, is superimposed on the recording material 2 aligned by the aligning roller 7, thereby gives a charge of the reverse polarity of the charging polarity of the toner to the recording material 2 by the transfer device 15 from the back side of the recording material 2, and is transferred to the recording material 2 due to the electrostatic force.

The recording material 2 with the toner image transferred to is conveyed to the fixing device 8 and is heated or pressurized by the fixing device 8, thus the toner is fixed on the recording material 2. The recording material 2 after end of image formation is discharged onto the receiving tray 9 via the discharge rollers 10. On the other hand, the residual toner remaining on the photosensitive drum 11 without transferred is removed by the cleaning device 16.

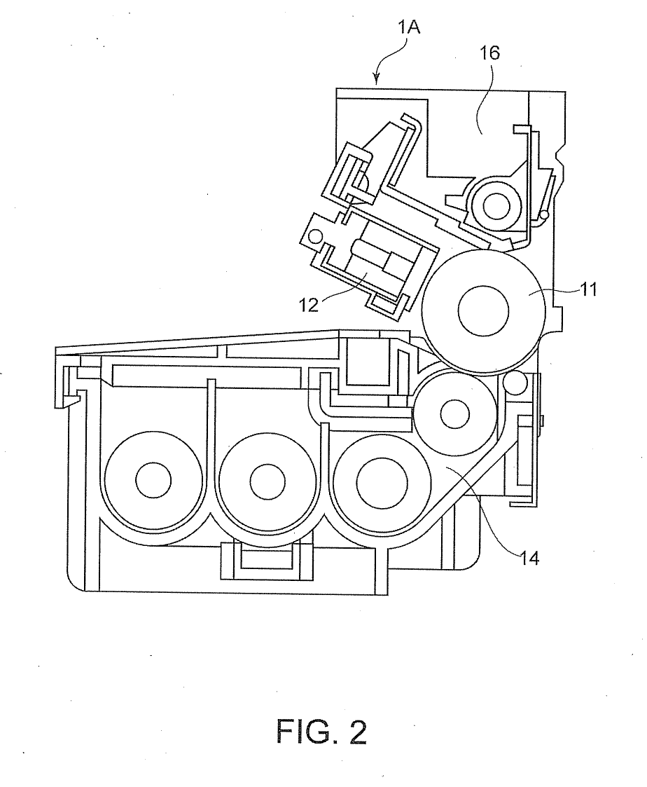

Next, the charger 12 in the process cartridge 1A will be explained in detail. FIG. 2 is a cross sectional view of the process cartridge 1A. The process cartridge 1A is composed of the photosensitive drum 11, charger 12, developing device 14, and cleaning device 16. The process cartridge can be removed from the main body 1.

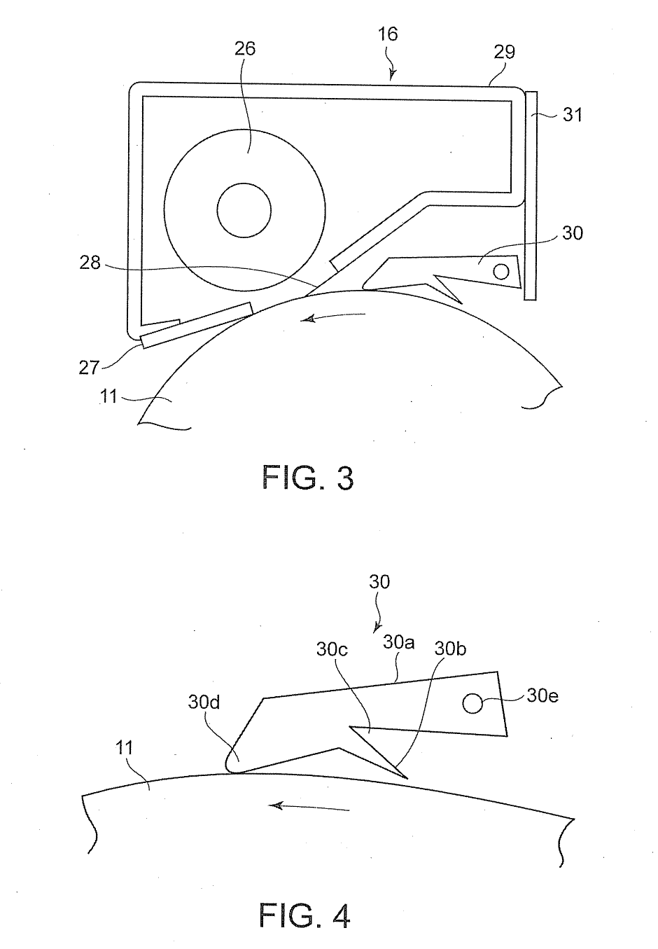

Next, the cleaning device 16 will be explained. As shown in FIG. 3, the cleaning device 16 is composed of a cleaner auger 26, an elastic cleaning blade 27, a recovery blade 28, and a housing 29 for covering these units. The cleaning device 16 is provided on the upper part of the photosensitive drum 11.

Next, a protective claw 30 will be explained. As shown in FIG. 4, a main body 30a of the protective claw 30 is made of polyamide (PAI) or polyimide (PI) with a thickness of 1 to 1.5 mm. The main body 30a is composed of a leading end portion 30b projected so as to approach the surface of the photosensitive drum 11, a recording material receiving portion 30c formed in a V shape from the leading end portion 30b, a positioning portion 30d for making contact with the surface of the photosensitive drum 11 by its own weight, and a shifting shaft 30e for supporting rotatably the main body 30a. The positioning portion 30d makes contact with the surface of the photosensitive drum 11 by its own weight, so that is no need to install a pressing member such as a spring to make contact with it. The main body 30a of the protective claw 30 of this embodiment is composed of the leading end portion 30b, when the recording material 2 enters, for separating the recording material 2 from the photosensitive drum 11 and guiding it to the sheet receiving portion 30c and the positioning portion 30d for making contact with the photosensitive drum 11 and positioning the main body 30a of the protective claw 30. The leading end portion 30b is adjacent to the surface of the photosensitive drum 11 via an interval of about 50 μm.

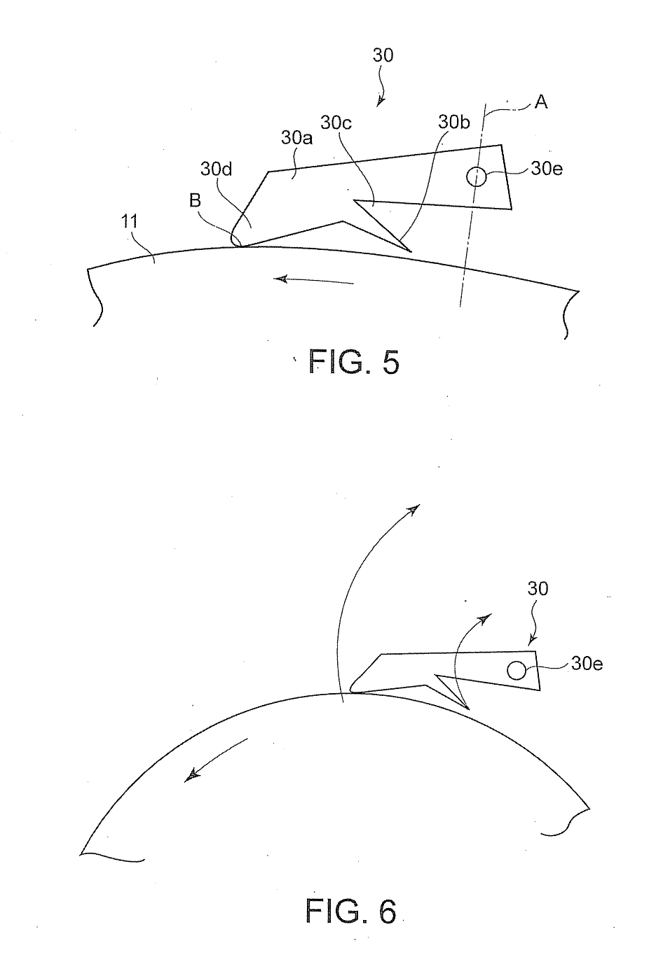

The position relationship between the leading end portion 30b and the positioning portion 30d will be explained by referring to FIG. 5. The shortest line connecting the shifting shaft 30e and photosensitive drum 11 is assumed as a line A. Further, the point of contact between the positioning portion 30d and the photosensitive drum 11 is assumed as a point B.

The leading end portion 30b of the main body 30a of this embodiment is positioned on the downstream side of the line A in the rotational direction of the photosensitive drum 11 and the leading end portion 30b is positioned halfway between the line A and the point B.

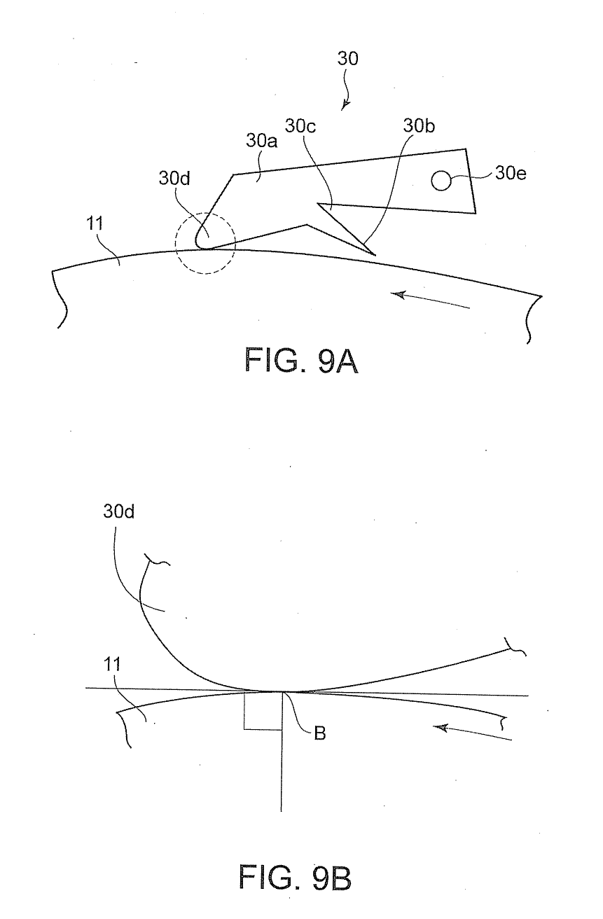

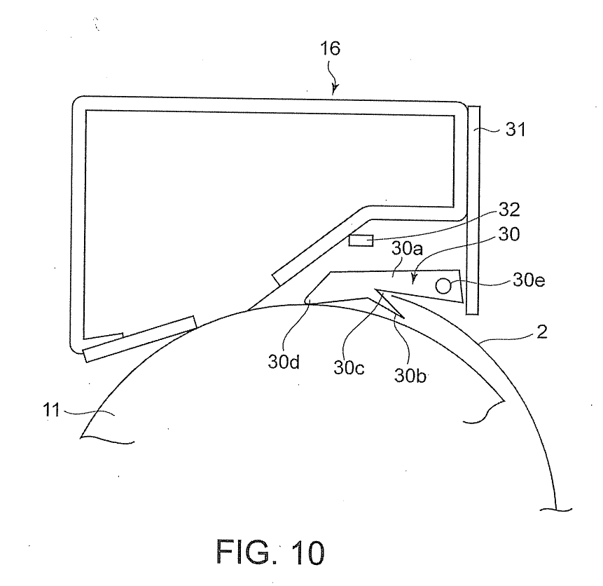

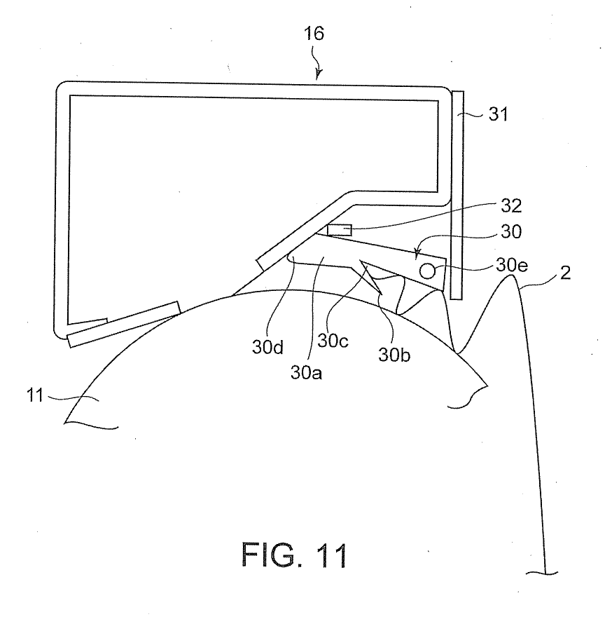

Next, the structure of the positioning portion 30d will be explained by referring to FIGS. 9A and 9B. The portion enclosed by the dotted line shown in FIG. 9A is enlarged and shown in FIG. 9B. The contact portion of the positioning portion 30d with the photosensitive drum 11 is in a curved shape. As shown in FIG. 9B, the curved portion makes contact with the surface parallel with the tangent at the contact point B on the photosensitive drum 11.

As shown in FIG. 6, the main body 30a of the protective claw 30 rotates around the shifting shaft 30e. Therefore, when the recording material 2 enters the sheet receiving portion 30c of the main body 30a, the leading end portion 30b rotates around the shifting shaft 30e in the direction separating from the photosensitive drum 11. Similarly, the positioning portion 30d rotates in the direction separating from the photosensitive drum 11. Here, to restrict the rotational distance of the main body 30a, if the main body 30a rotates to a certain extent, the main body 30a of the protective claw 30 makes contact with the cleaning device 16 and is restricted so as not to rotate more.

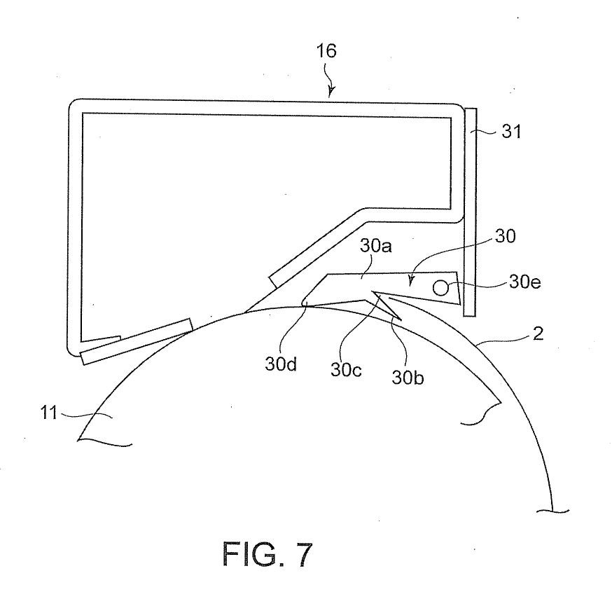

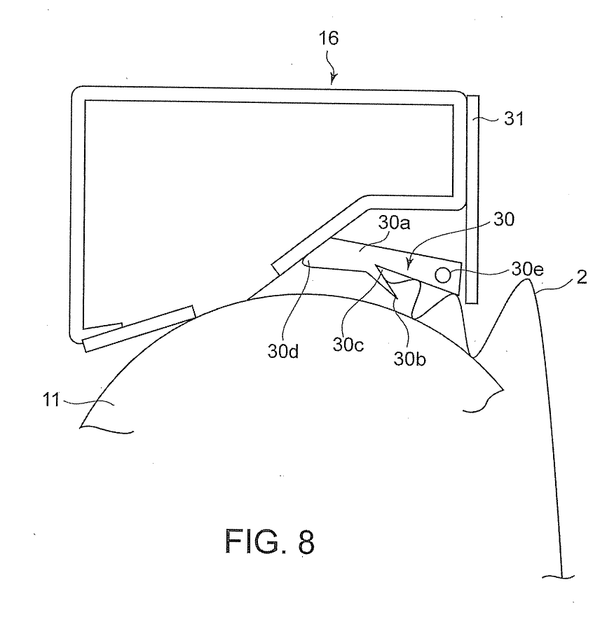

The operation of the protective claw 30 when the recording material 2 actually enters the sheet receiving portion 30c of the protective claw 30 will be explained be referring to FIGS. 7 and 8. When the recording material 2 enters the protective claw 30 without conveyed by a conveying guide 31, the recording material 2 is guided to the sheet receiving portion 30c by the leading end portion 30b. The recording material 2 guided to the sheet receiving portion 30c pushes up the main body 30a of the protective claw 30 in the direction separating from the photosensitive drum 11. By doing this, the main body 30a rotates around the shifting shaft 30e.

The main body 30a of the protective claw 30 of this embodiment, since the leading end portion 30b and positioning portion 30d are separated from each other and are provided so as to rotate, when the recording material 2 enters the protective claw 30, rotates in the direction of separating the protective claw 30 from the photosensitive drum 11. Even if the recording material 2 makes contact with the leading end portion 30b, the protective claw 30 will not damage the photosensitive drum 11.

Further, the main body 30a of the protective claw 30, since the positioning portion 30d is curved, makes contact with the photosensitive drum 11 on a plane due to the curved portion, so that the load thereof on the photosensitive drum 11 is reduced. And, even when the photosensitive drum 11 rotates reversely, the load thereof on the photosensitive drum 11 is lightened.

Another embodiment will be explained by referring to FIGS. 7 and 8. In the main body 30a of the protective claw 30 of this embodiment, when the recording material 2 enters, the shifting shaft 30e rotates. A sensor for detecting rotation of the protective claw 30 is provided. For example, as shown in FIG. 7, at the position on the upper part of the protective claw 30 with which the protective claw 30 makes contact when the protective claw 30 rotates, a switch 32 is provided. As shown in FIG. 8, if the recording material 2 enters the protective claw 30 and the protective claw 30 rotates, the protective claw 30 makes contact with the switch 32 provided on the upper part of the protective claw 30. If the switch 32 detects the contact with the protective claw 30, the main body 30a judges an occurrence of sheet jamming.

Conventionally, a passing sensor is provided respectively at the preceding stage and succeeding stage of the transfer region where the photosensitive drum 11 and transfer device 15 make contact with each other, and when the recording material 2 passes through the passing sensor at the preceding stage of the transfer region and the passing sensor at the succeeding stage of the transfer region does not detect passing of the recording material 2 after a predetermined period of time, the main body 34 recognizes an occurrence of jamming.

In the conventional means for detecting jamming of the recording material 2, it is necessary to install two sensors. Further, in relation to the arrangement of each device, the passing sensor at the succeeding stage of the transfer region may not be provided at a location immediately after leaving the transfer region. In this case, it takes a lot of time to recognize an occurrence of jamming after it occurs. However, when this embodiment is adopted, if the recording material 2 is jammed, an occurrence of jamming can be recognized immediately.

In the embodiment aforementioned, the photosensitive drum 11 is used as an image carrying member, though the present invention is not limited to it, and intermediate transfer media such as an intermediate transfer drum and an intermediate transfer belt are included in the image carrying members.

Although the invention is shown and described with respect to certain illustrated aspects, it will be appreciated that equivalent alterations and modifications will occur to others skilled in the art upon the reading and understanding of this specification and the annexed drawings. In particular regard to the various functions performed by the above described components, the terms used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention.

What is claimed is:

1. A protective claw provided on an upstream side of a cleaning device in a rotational direction of an image carrying member, comprising:
a main body;
a recording material receiving portion formed on the main body so as to receive a recording material from a leading end thereof; and
a rotating shaft, when receiving the recording material by the recording material receiving portion, configured to support the main body so as to make the recording material receiving portion rotate in a direction separating from the image carrying member.

2. The protective claw according to claim 1, wherein the receiving portion has a leading end configured to separate the recording material from the image carrying member and the leading end is close to the image carrying member.

3. The protective claw according to claim 2 further comprising:
a positioning portion, so as to make the leading end keep the position close to the image carrying member, configured to make contact with the image carrying member at a position on a downstream side of the leading end in a rotational direction of the image carrying member.

4. The protective claw according to claim 3, wherein the positioning portion has a curved shape and the curved portion makes contact with the image carrying member.

5. The protective claw according to claim 3, wherein the positioning portion is in contact with a surface of the image carrying member by an own weight of the main body.

6. The protective claw according to claim 1, wherein the main body is made of polyamide or polyimide.

7. A process cartridge comprising:
an image carrying member;
a charger arranged in a rotational direction of the image carrying member configured to charge the image carrying member;
an exposure device to irradiate light to the charged image carrying member and form an electrostatic latent image;
a developing device to supply toner to the electrostatic latent image and form a toner image on the image carrying member;
a transfer device to transfer the toner image onto a recording material;
a cleaning device configured to remove toner remaining on the image carrying member after transferring the toner image onto the recording material; and
a protective claw provided on an upstream side of the cleaning device in the rotational direction of the image carrying member,
wherein the protective claw comprises:
a main body;
a recording material receiving portion formed on the main body so as to receive the recording material from a leading end thereof; and
a rotating shaft, when receiving the recording material by the recording material receiving portion, configured to support the main body so as to make the recording material receiving portion rotate in a direction separating from the image carrying member.

8. The process cartridge according to claim 7, wherein the receiving portion has a leading end to separate the recording material from the image carrying member and the leading end is close to the image carrying member.

9. The process cartridge according to claim 8, wherein the protective claw includes:
a positioning portion, so as to make the leading end keep the position close to the image carrying member, configured to make contact with the image carrying member at a position on a downstream side of the leading end in a rotational direction of the image carrying member.

10. The process cartridge according to claim 9, wherein the positioning portion of the protective claw has a curved shape and the curved portion makes contact with the image carrying member.

11. The process cartridge according to claim 9, wherein the positioning portion of the protective claw is in contact with a surface of the image carrying member by an own weight of the main body.

12. The process cartridge according to claim 7, wherein the main body of the protective claw is made of polyamide or polyimide.

13. The process cartridge according to claim 7 further comprising:
a switch, when the protective claw rotates in a direction that the recording material receiving portion separates from the image carrying member, provided at a position with which the protective claw makes contact.

14. An image forming apparatus comprising:
an image carrying member;
a charger arranged in a rotational direction of the image carrying member to charge the image carrying member;
an exposure device to irradiate light to the charged image carrying member and form an electrostatic latent image;
a developing device to supply toner to the electrostatic latent image and form a toner image on the image carrying member;
a transfer device to transfer the toner image onto a recording material;
a fixing device configured to fix the transferred toner image on the recording material;
a cleaning device configured to remove toner remaining on the image carrying member after transferring the toner image onto the recording material; and
a protective claw provided on an upstream side of the cleaning device in the rotational direction of the image carrying member,
wherein the protective claw comprises:
a main body;
a recording material receiving portion formed on the main body so as to receive the recording material from a leading end thereof; and
a rotating shaft, when receiving the recording material by the recording material receiving portion, configured to support the main body so as to make the recording material receiving portion rotate in a direction separating from the image carrying member.

15. Then image forming apparatus according to claim 14, wherein the receiving portion has a leading end to separate the recording material from the image carrying member and the leading end is close to the image carrying member.

16. Then image forming apparatus according to claim 15, wherein the protective claw includes:
a positioning portion, so as to make the leading end keep the position close to the image carrying member, to make contact with the image carrying member at a position on a downstream side of the leading end in a rotational direction of the image carrying member.

17. Then image forming apparatus according to claim 16, wherein the positioning portion of the protective claw has a curved shape and the curved portion makes contact with the image carrying member.

18. Then image forming apparatus according to claim 16, wherein the positioning portion of the protective claw is in contact with a surface of the image carrying member by an own weight of the main body.

19. Then image forming apparatus according to claim 14, wherein the main body of the protective claw is made of polyamide or polyimide.

20. Then image forming apparatus according to claim 14 further comprising:
a switch, when the protective claw rotates in a direction that the recording material receiving portion separates from the image carrying member, provided at a position with which the protective claw makes contact.
